(19) United States
(12) Patent Application Publication
(10) Pub. No.: US 2011/0179124 A1
(43) Pub. Date: Jul. 21, 2011

(54) Short Range Data Transmission Device For Social Networking and Related Method of Use

(75) Inventor: Jerry Fielding, JR., Brighton, MI (US)

(73) Assignee: Love Button, LLC, Wixom, MI (US)

(21) Appl. No.: 13/008,297

(22) Filed: Jan. 18, 2011

Related U.S. Application Data
(60) Provisional application No. 61/296,943, filed on Jan. 21, 2010.
(60) Provisional application No. 61/308,003, filed on Feb. 25, 2010.

(51) Int. Cl. G06F 15/16

(52) U.S. Cl. 709/206; 709/204

(57) ABSTRACT

A method for social networking that involves registering a plurality of individuals who will be users of a social network. A plurality of electronic user devices may be provided that are adapted to be carried by each of the users. Each said electronic user device may have an identification code and may be able to wirelessly harvest the identification code of any other one of the electronic user devices when two or more of the electronic user devices come within a predetermined distance of one another. A host subsystem may be used to coordinate messaging and a transfer of predetermined types of information between the first and second users.

### CROSS-REFERENCE TO RELATED APPLICATIONS

The present application claims priority from U.S. Provisional application Ser. No. 61/296,943 filed Jan. 21, 2010, and also from U.S. Provisional application Ser. No. 61/308,003, filed Feb. 25, 2010, the entire disclosures of both documents being incorporated herein by reference into the present application.

### FIELD

The present disclosure relates generally to a short range data transmission device for social networking. The present disclosure also relates to an internet-based system for social networking.

### BACKGROUND

The background description provided herein is for the purpose of generally presenting the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Social networking or dating is modernly carried out in various manners. Each known manner is associated with specific drawbacks and/or limitations.

In the oldest known form of social networking, people meet face-to-face establishing an introduction. If both parties desire, a relationship may begin to develop. Many people are uncomfortable in such circumstances or would otherwise prefer not to meet strangers face-to-face.

Even when one individual is not shy about making an introduction to a person he/she would like to meet, the location and circumstances of the encounter may not be conducive to the one individual making an introduction of himself/herself to the other. For example, a situation can arise where two individuals may notice one another in a setting that is not conducive to carrying to making an introduction, but an interest to meet the other may still arise for one or both individuals. Such settings could involve two individuals standing in close proximity to one another in line at a check out register at a store, or possibly one individual noticing the another when both are at a shopping mall, or when both individuals pass one another on a sidewalk. Many other brief encounters can arise where one individual may take notice of another individual that he/she would like to meet, but where it would be impractical or awkward to approach the other individual and make an attempt to make an introduction. Once the brief encounter passes, however, the possibility of encountering the other individual again at a future time may be virtually non-existent.

In addition, various internet websites for social networking or dating are known. Most of these websites allow a user to search for prospective dates through a database. The available information on the candidates is limited to information and/or pictures submitted by the candidates themselves. This information may often be misleading.

While various techniques for social networking are known, a need for continuous improvement in the relevant art remains.

### SUMMARY

In one aspect the present disclosure relates to a method for social networking. The method may comprise using a system to register a plurality of individuals who will be users of a social network. A plurality of electronic user devices may be provided that are adapted to be carried by each of the users. Each said electronic user device may have an identification code and may be able to wirelessly harvest the identification code of any other one of the electronic user devices when two or more of the electronic user devices come within a predetermined distance of one another. A first one of the electronic user devices may be used to wirelessly harvest the identification code of a second one of the electronic user devices when the first and second electronic user devices come within the predetermined distance of one another, and wherein the first electronic user device is associated with a first user who is registered with the system and the second electronic user device is associated with a second user who is registered with the system. The system may be used to coordinate messaging and a transfer of predetermined types of information between the first and second users.

In another aspect the present disclosure relates to a system for social networking. The system may comprise a host subsystem for containing information about a plurality of users who are registered to use the social networking system, and providing an account for each said user who is registered to use the system. A plurality of electronic user devices are included that are uniquely associated with each of the users, with each of the electronic user devices including a unique identification code. Each of the electronic user devices includes a wireless communications transceiver for wirelessly transmitting the identification code of its respective said electronic user device, and for wirelessly receiving the identification codes of other ones of the electronic user devices when any two or more ones of the electronic user devices come within a predetermined distance of one another. Each of the electronic user devices further may be adapted to store received identification codes from other ones of the electronic user devices and to enable uploading of the identification codes stored thereon to the host subsystem. The host subsystem may be adapted to manage and coordinate messaging between the users associated with the received identification codes.

In still another aspect of the present disclosure a social networking system is disclosed. The system may include a host server subsystem for containing information about a plurality of users who are registered to use the social networking system, and providing an account for each said user who is registered to use the system. A plurality of electronic user devices may be included that are associated with each of the users, with each of the electronic user devices including a unique identification code. Each of the electronic user devices may include a wireless communications transceiver for automatically wirelessly transmitting the identification code of its respective electronic user device, and for automatically wirelessly receiving the identification codes of other ones of the electronic user devices when any two or more ones of the electronic user devices come within a predetermined distance of one another. The transmitting and the receiving of identification codes may be accomplished without user commands. Each of the electronic user devices further may be adapted to store received identification codes from other ones of the electronic user devices and to enable uploading of the identification codes stored thereon to the host server subsystem. The host server subsystem may be adapted to coordinate transmitting information associated with each user whose identification code has been received by the electronic device of a first one of the user's, to the first user. The host server subsystem may enable the first user to select at least one second user from the group of users associated with the received identification codes that the first user wishes to send a message to, and furthermore to generate a message to the second user. The host subsystem may also enable the second user to be provided with a picture of the first user, and further to enable the second user to send a reply message to the first user when the second user wishes to communicate further with the first user.

### BRIEF DESCRIPTION OF DRAWINGS

The present disclosure will become more fully understood from the detailed description and the accompanying drawings, wherein:

FIG. 1 is a perspective view of a short range data transmission device according to the present teachings;

FIG. 2 is a top view of the data transmission device of FIG. 1;

FIG. 3 is a side view of the data transmission device of FIG. 1;

FIG. 4 is a first end view of the data transmission device of FIG. 1;

FIG. 5 is a second end view of the data transmission device of FIG. 1;

FIG. 6 is a schematic view of the data transmission device of FIG. 1;

FIG. 7 is a functional block diagram of a social networking system in accordance with the present teachings, the system including a host server having a database system;

FIG. 8 is functional block diagram of the database system of FIG. 7;

FIG. 9 is a schematic view of another social networking system in accordance with the present teachings;

FIG. 10 is a schematic view of another social networking system in accordance with the present teachings;

FIG. 11 is a high level diagrammatic view showing another implementation of the present disclosure in which different types of electronic devices carried by one individual may be used to harvest identification information from other individuals, where all the individuals are subscribers to a social networking system in accordance with the present disclosure;

FIG. 11A is a high level block diagram of major subsystems of one embodiment of a smartphone-type user device shown in FIG. 11;

FIG. 11B is a high level block diagram, of exemplary components that may be used in the dedicated user device shown in FIG. 11;

FIG. 12 is a high level block diagram of various components that may be employed by one embodiment of the host server subsystem of FIG. 11;

FIG. 13 is a high level flow diagram illustrating various operations that may be performed by the system of FIG. 11 during an initial registration/setup procedure for a new subscriber using the system shown in FIG. 11;

FIG. 14 is high level flow diagram illustrating various operations that may be carried out by one embodiment of the system of FIG. 11 in coordinating a contact between two users of the system; and

FIG. 15 is a high level flow diagram illustrating various operations that may be performed by one embodiment of the system when the dedicated user device is used.

### DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical OR. It should be understood that steps within a method may be executed in different order without altering the principles of the present disclosure.

As used herein, the general term social networking and the more specific term dating are used interchangeably. In this regard, the present teachings are described in reference to an exemplary use involving dating. It will be understood, however, that the present teachings may be used for social networking other than dating.

The present disclosure generally pertains to a novel short range data transmission device and related system and method for social networking.

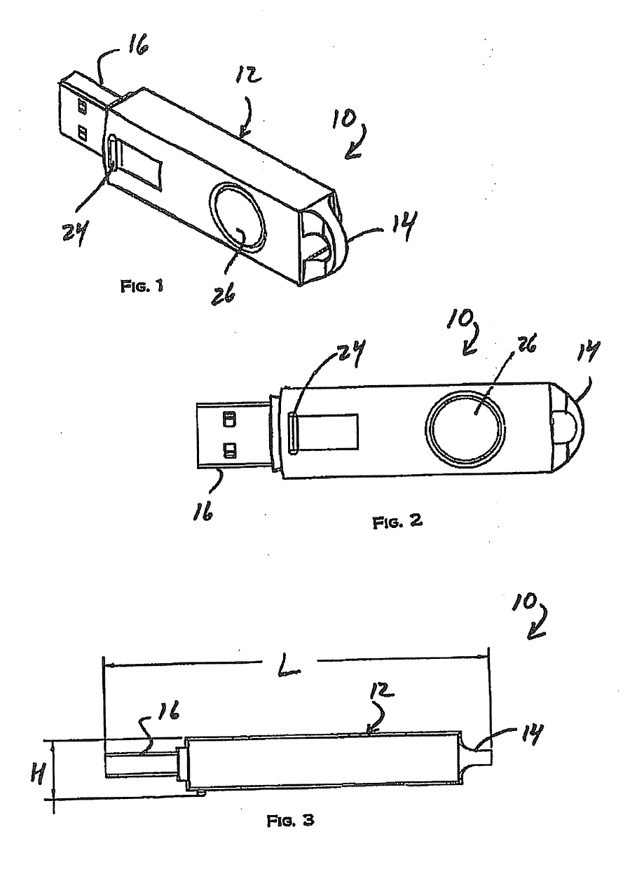

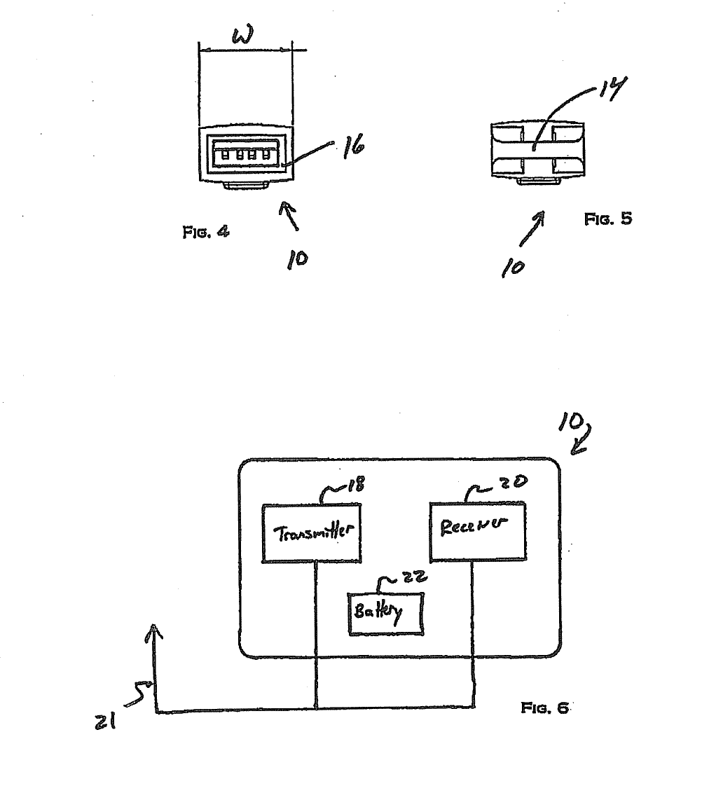

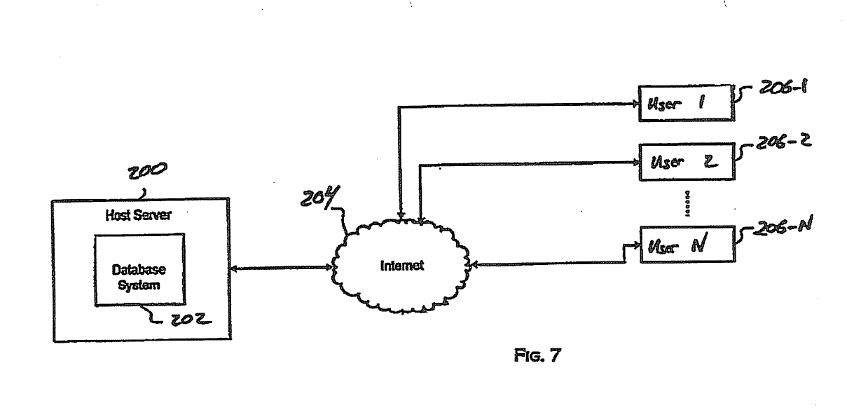

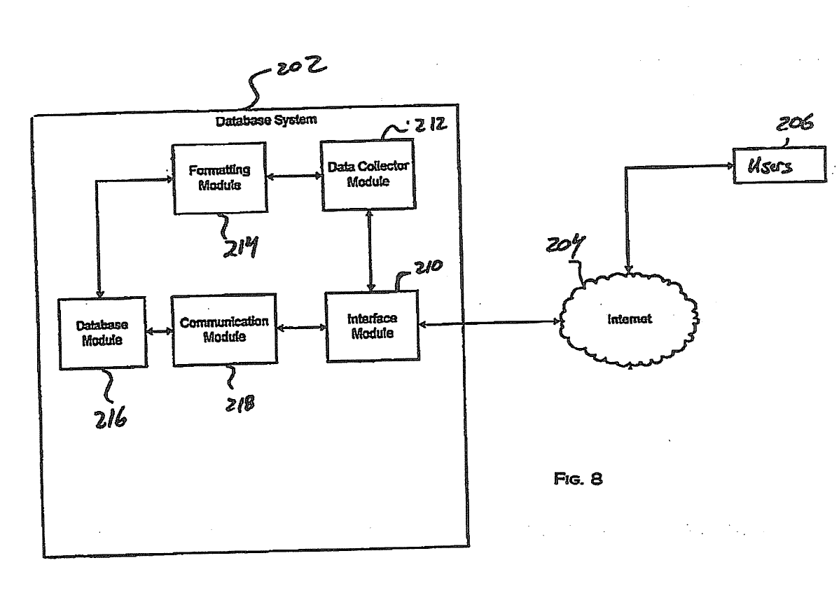

With initial reference to FIGS. 1 through 6, a short range transmission device, which will be referred to simply as a “transceiver”, in accordance with the present teachings is generally illustrated and identified at reference character 10. It will be understood that FIGS. 1 through 5 are drawn approximately to scale. FIG. 6 schematically illustrates one embodiment of the transceiver 10.

The transceiver 10 may include a housing 12, a first end 14 and a second end 16. The housing 12 may be generally rectangular in shape. Alternatively, the housing 12 may be any other configuration that facilitates easy and convenient handling.

As generally shown in the schematic diagram of FIG. 6, the housing 12 may house a wireless signal transmitter 18 and a wireless receiver 20. The transmitter 18 and receiver 20 may be coupled to an antenna 21. Additionally, the housing 12 may house a battery 22 for powering the transceiver 10 in a well known manner. Furthermore, it will be understood that the transceiver 10 is provided with resident software sufficient to carry out the functions generally described herein. The details of the software will be understood to be conventional insofar as the present teachings are concerned.

The transceiver 10 is further illustrated to include a switch 24 and a control member or button 26. The switch 24 may be displaceable between an ON position and an OFF position. In the ON position, which is shown in the drawings, power may be provided by the battery 22 and the transceiver device 10 may send and receive signals in the manner discussed below.

The first end 14 of the transceiver 10 may define a loop. The loop may be engaged by a key ring, for example.

A second end 16 of the transceiver 10 may define a Universal Serial Bus (USB) connector. Alternatively, the transceiver 10 may be configured to wirelessly or otherwise communicate with a personal computer or handheld device in a conventional manner.

The transceiver 10 is illustrated to generally include a length L, a height H, and a width W. In one particular application, the length L may be approximately 2.75 inches, the height H may be approximately 0.5 inches and the width W may be approximately 0.68 inches. It will be understood that these dimensions are merely exemplary. In this regard, the dimensions may vary within the scope of the present teachings.

The transceiver 10 will thus be understood, in the embodiment described above, to be somewhat similar in general appearance and physical dimensions to a thumb drive type memory device or memory stick. As such, the transmission device is extremely compact and lightweight, and therefore very easy to carry in a pocket or handbag of an individual, or possibly even on a key ring with other keys. It will be understood, however, that the present teachings may be alternatively embodied in other devices. For example, and without limitations, the present teachings may be embodied in a cellular telephone.

Prior to addressing the use of the transceiver 10, an exemplary system for social networking with the transceiver 10 will be described. With reference to FIG. 7, a host server 200 comprising a database system 202 according to the present teachings is shown. The host server 200 may communicate with the Internet 204 or any other wide area network or local area network, although it is envisioned that the Internet will likely have the widest applicability of the present system and method. Although a single host server 200 is shown in FIG. 7, a plurality of host servers may be utilized instead. In other words, the database system 202 may be implemented across a cluster of host servers that are networked using local and/or wide area network topologies, for example.

User-1 206-1, User-2 206-2, . . . , and User-N 206-N (collectively users 206), denote users seeking social connections or dates. As will be described further below, the users 206 may access the database system 202 via the Internet 204. The users 206 may access the Internet 204 using a suitable handheld communication device or a computer.

Referring now to FIG. 8, the database system 202 may comprise an interface module 210, a data collector module 212, a formatting module 214, and a database module 216. Additionally, the database system 202 may comprise a communication module 218.

The interface module 210 may interface the database system 202 to the Internet 204. The users 206 may communicate with the database system 202 via the interface module 210. The interface module 210 may control access to the database system 202 using one or mode authentication schemes. The authentication schemes may include, but are not limited to, usernames, passwords, and unique identifying information associated with a specific individual.

The data collector module 212 may collect data input by the users 206. The formatting module 214 may format the data into a desired format. The database module 216 may store the formatted data.

The communication module 218 may provide multimedia (text, audio, and video) communication services and/or applications to the users 206. The communication module 218 may provide these services or applications via the Internet 204. The users 206 may utilize these services or applications to communicate with each other efficiently.

The communication module 218 may include audio-visual (AV) conferencing capabilities and instant messaging capabilities. The communications module 219 may communicate with the database module 216 and the interface module 210. The AV capabilities of the communications module 218 may enable the users 206 to visually interact with prospective social connections or dates. The messaging capabilities of the communications module 218 may allow the users 206 to exchange messages (e.g., emails) in a secure manner, or even to communicate essentially in real time through an instant messaging-like application.

Exemplary use of the transceiver 10 will now be described. Initially, a user 206 with a transceiver 10 will plug the transceiver 10 into a personal computer or otherwise interface the transceiver 10 with a personal computer or suitable handheld device. Software resident on the transceiver 10 will prompt the personal computer, for example, to connect with a predetermined website on the Internet 204. During this first communication of the transceiver 10 with the website, the user will be prompted to enter certain personal information. This personal information may include contact information, a picture of the user 206, etc. Where use of the system involves fees, the personal information may further include credit card information or other forms of billing information. Upon entry of the required information, the user 206 is effectively registered with the system and the user 206 is assigned a unique identifier. The unique identifier may be a ten digit code, for example.

Activation of the transceiver 10 by the user 206 through pressing of the button 26 will cause the transmitter 18 to transmit a signal with the unique identifier. The transmitter 18 has a generally short range. In certain applications, the transmitter has a range of approximately 25-35 feet.

Upon registration of a plurality of devices 10, each device 10 is operable to function as a receiver or a sender. The signal generated by the transmitter 18 of a sender's device may include the sender's unique identifier and may be received by another transmitter device 10 (i.e., receiver device) that is within range. The receiver device 10 may receive and store the unique identifier. According to one particular application, the device 10 may include an internal memory capable of holding 100 transmitted signals.

Practically, a first user 206-1 may identify a second user 206-2 having a transceiver 10 that he or she would like to meet. The first user 206-1 or sender transmits the unique identifier that is received by the second user 206-2 or receiver. The transceiver 10 may include means for notification in the form of vibration or a light indicating that a unique identifier from a sender has been received. The second user 206-2 may or may not know the origination of the signal. In this manner, the first user 206-1 may remain confidential for the time being.

When the second user 206-2 communicates his or her transmission device with a personal computer or hand-held device, the unique identifier of the first user 206-1 will be sent to the predetermined website. The predetermined website may optionally display predetermined personal data of the first user 206-1. For example, the predetermined personal data of the first user 206-1 may be limited to a photograph of the first user.

At this point, the second user 206-2 may be prompted for a decision as to whether he or she would like to consider establishing a relationship with the first user 206-1. The available options may include: (1) ignore or que; (2) decline (e.g., no thank you); 93) block (this blocks any further signals from the particular sender); and (4) accept. For particular applications, selecting “accept” may operate to send the recipient's (i.e., second user 206-2) photograph back to the first user 206-1. If user 206-2 is the recipient that the first user 206-1 intended to contact, then the first user 206-1 may then open a dialogue box to begin communication via messaging. The system may offer a video connection or email contact information if a prospective relationship is desired.

The systems and methods described above may be implemented by a computer program executed by one or more processors. The computer program can reside on a tangible computer-readable medium such as but not limited to memory, nonvolatile data storage, and/or other suitable tangible storage mediums.

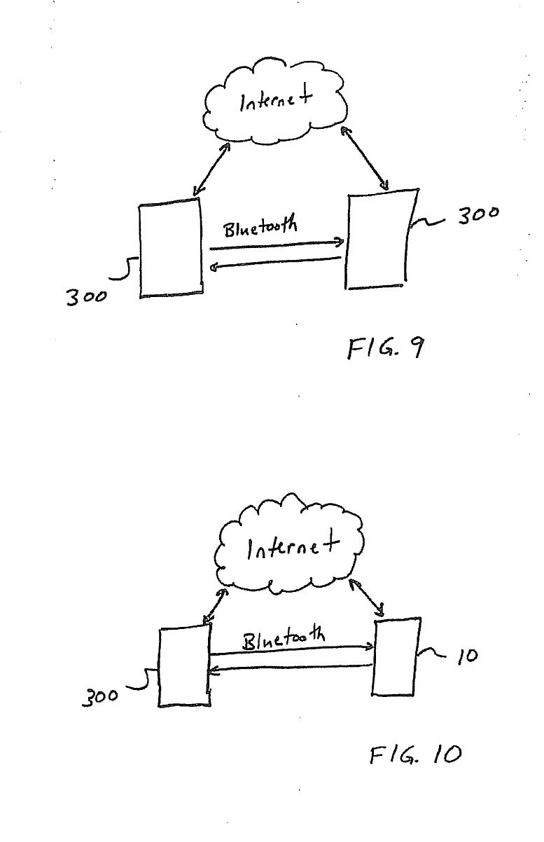

Turning to FIG. 9, a schematic view illustrating another social networking system in accordance with the present teachings is provided. As illustrated, the system may include first and second substantially identical transceiver devices 300. In one particular implementation the devices 300 may be “smart phones” (i.e., phones containing additional processing components to run one or more application programs) or other personal computing or hand-held electronic devices. To the extent not otherwise described, it will be understood that the transceiver devices 300 function substantially identical to the transceiver 10 described above.

The transceiver devices 300 may wirelessly send and receive data using the BLUETOOTH® wireless signal communications protocol (hereinafter simply the “BLUETOOTH® communications protocol”). In this manner, the transceiver devices 300 may communicate data between themselves or with a computer. The transceiver devices 300 may alternatively or additionally transmit data with other devices 300 via the Internet or via other wireless protocols.

The transceiver devices 300 may be provided with software sufficient to accomplish the transmission and other functions discussed above. The transceiver devices 300 may each include a graphical interface for the user. With the software and the graphical interface, the transceiver devices 300 need not be used with a personal computer. The software may be provided in an application that may be downloaded from the Internet.

The data transmitted by the transceiver devices 300 may include a stored photograph of the sender, and/or a stored profile of the sender, and/or a prepared text message. The BLUETOOTH® communications protocol may provide wireless transmission typically within a range of approximately 20-30 feet. Each transceiver device 300 may also include software for processing the incoming data. Similar to the discussion above concerning the transceiver 10, the transceiver 300 may prompt the user to select from options including: (1) ignore; (2) reject; (3) block; and (4) accept. The receiving transceiver 300 may prompt the user with a text message, indicator light or other form of notification upon receipt of a data transmission from some other transceiver 300 that has come within its wireless signal reception range.

Turning to FIG. 10, another social networking system in accordance with the present teachings is illustrated. This system may include one or more transceivers 300 (as described above) and one or more transceivers 10 (as described above). The transceivers 10 may be adapted to communicate with other mobile devices 10 or mobile devices 300 through the BLUETOOTH® communications protocol or through any other suitable wireless communications protocol. To the extent not otherwise described, it will be understood that the construction and operation of the system of FIG. 10 is consistent with the description provided above with respect to the other systems.

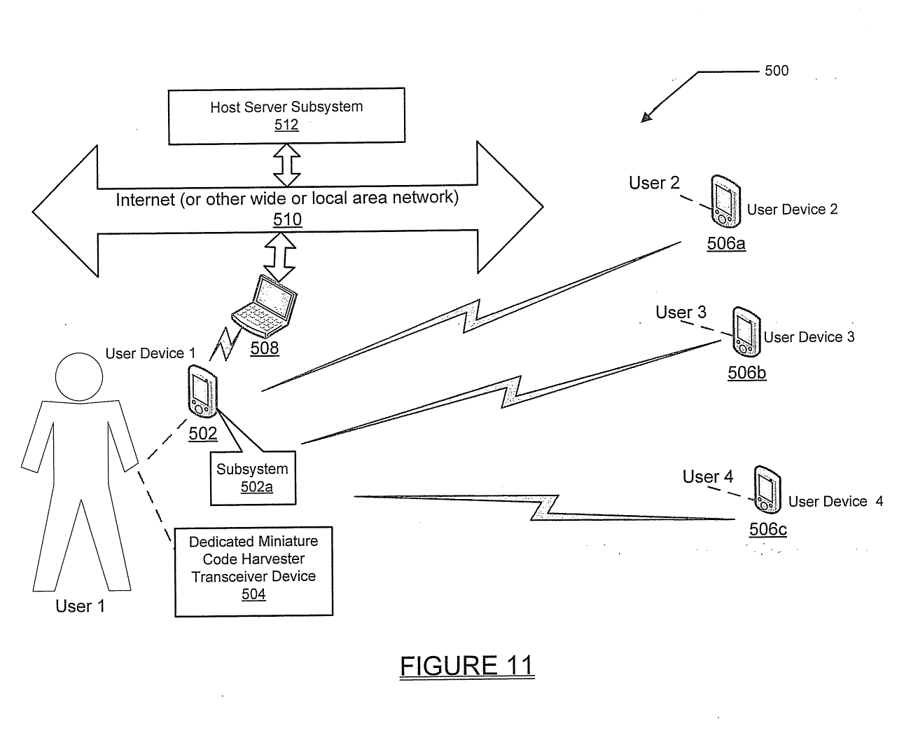

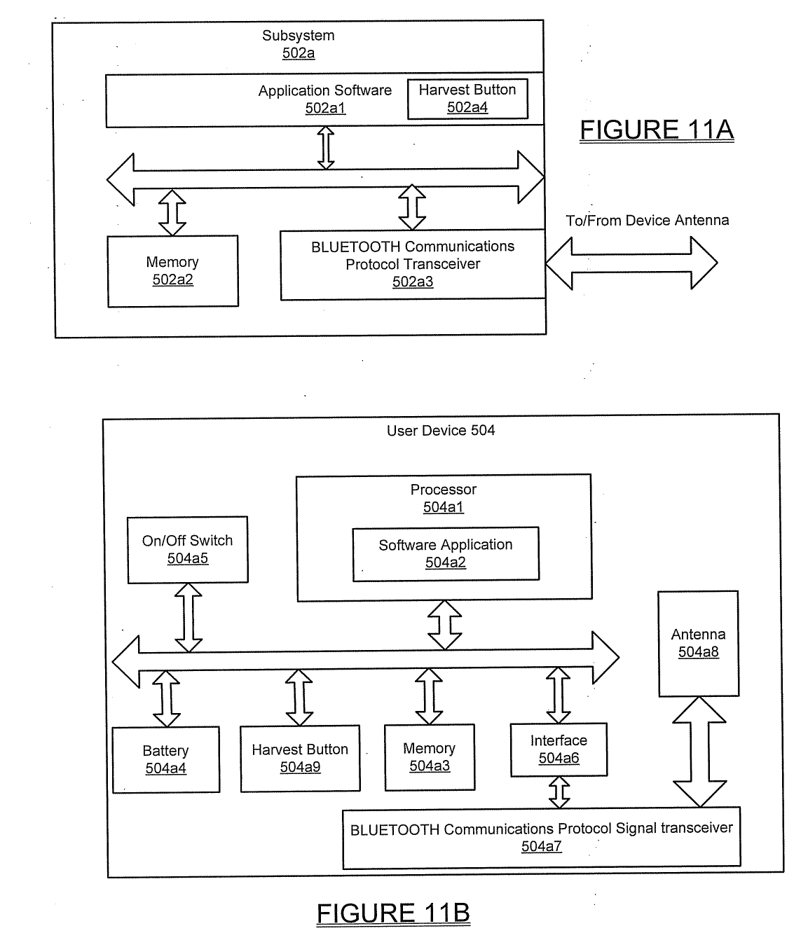

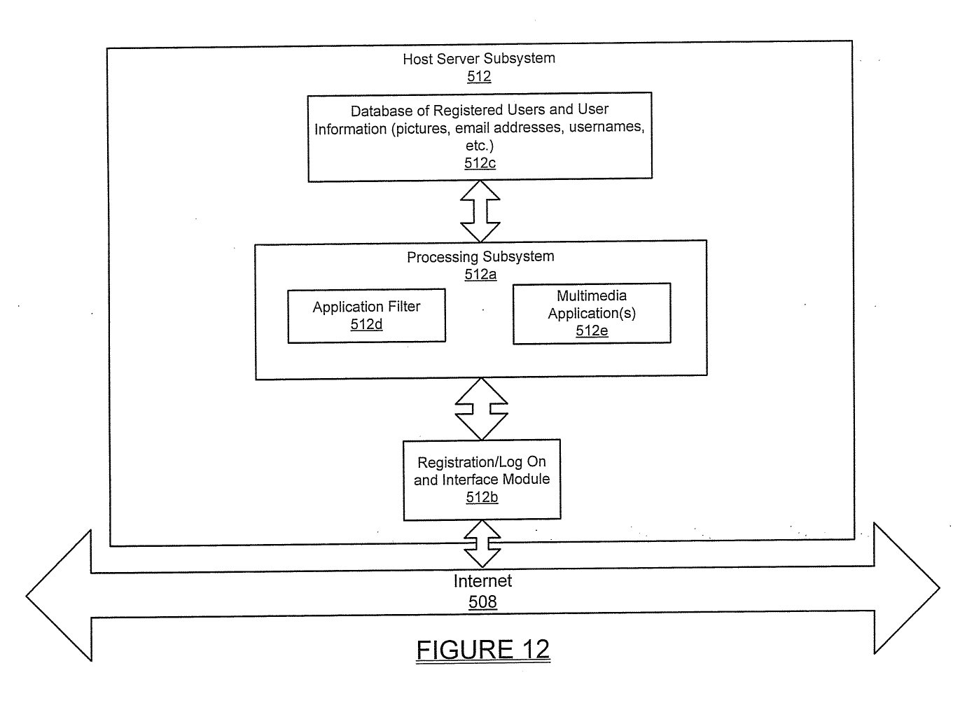

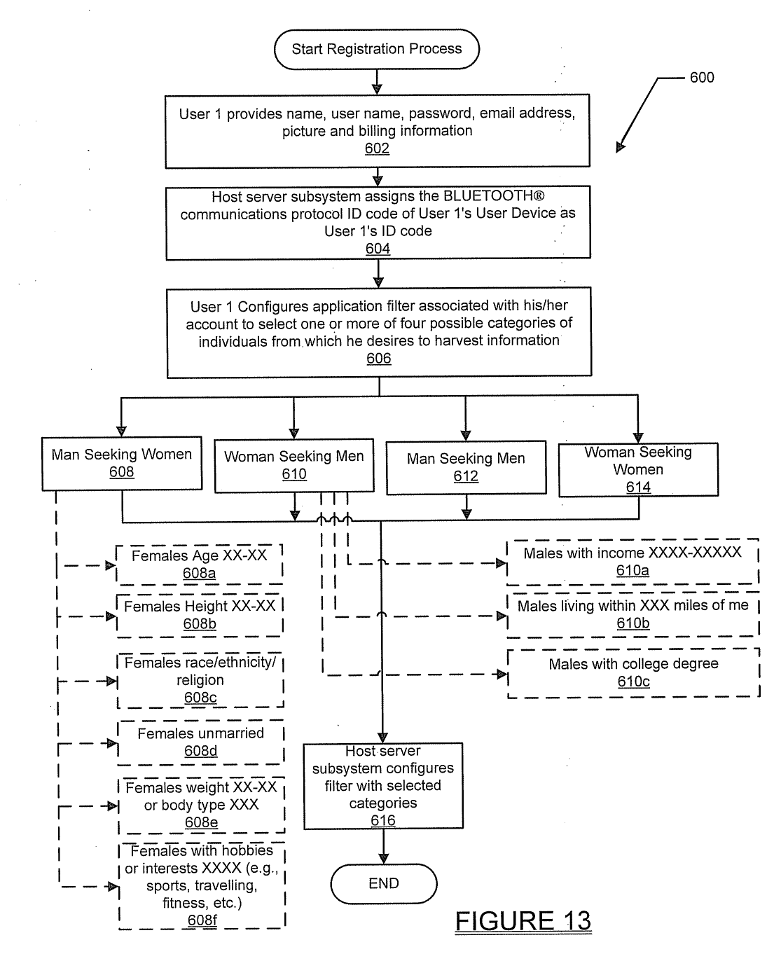

Referring now to FIG. 11, a system 500 in accordance with another embodiment of the present disclosure is illustrated. The system 500 in this embodiment may include either of two different types of electronic user devices 502 or 504 (hereinafter simply “user devices”) that a user may carry easily and conveniently on his/her person. User device 502 is a “smartphone” type device that forms a cellular phone but also includes one or more applications for handling other types of communications such as email messages, text messaging communications, etc. The user device 502 also includes a subsystem 502a, which will be described in greater detail momentarily, that operates to wirelessly harvest BLUETOOTH® communications protocol identification codes transmitted by other user devices 506a-506c whose users are also subscribers on the system 500. User device 504 forms a standalone, self-powered, dedicated miniature BLUETOOTH® communications protocol code harvester transceiver device (hereinafter simply user device 504).

With brief reference to FIG. 11A the subsystem 502a can be seen in greater detail. Subsystem 502a may include a software application 502a1 that runs on the user device 502. The software application may communicate with and control a memory 502a (such as a random access memory) and a BLUETOOTH® communications protocol code transceiver 502a3 (hereinafter simply the “transceiver 502a3”). The memory 502a2 may be used for storing BLUETOOTH® communications protocol identification codes that are harvested and may be of sufficient size to store hundreds or more such identification codes. The software application 502a1 may also control the operation of the transceiver 502a3 so that identification codes of external BLUETOOTH® communication protocol devices are harvested (i.e., without any prior user command or action) when detected, and also so that the BLUETOOTH® communication protocol identification code of the user device 502 is periodically transmitted (e.g., once per second) from the user device 502. The transceiver 502a3 may be in communication with the antenna of the user device 502 or a separate, dedicated antenna (not shown) may be used with the transceiver 502a3 to handle only the wireless bidirectional communications associated with the transceiver 502a3. The software application 502a1 may provide a “Harvest” button 502a4 on the display of the user device 502 that the user can press to harvest a BLUETOOTH® communication protocol code when the user comes into proximity of another individual who he/she desires to contact. Alternatively, the software application 502a1 could be configured so that it automatically and periodically (e.g., once every 1-5 seconds) searches to harvest BLUETOOTH® communication protocol codes whenever the application software 502a1 is operating. In this manner no manual commands from the user would be required for harvesting the BLUETOOTH® communication protocol codes of other individuals.

Referring to FIG. 118, one implementation of the user device 504 is shown. It will be appreciated that the external dimensions of the user device 504 may be in accordance with those described hereinbefore for device 10 of FIG. 1. Since user device 504 is a standalone component, it will be appreciated that a small number of additional components will typically be needed for its implementation. For example, the user device 504 may also include a processor 504a1 that runs a software application 504a2, with the software application 504a2 controlling reading/writing operations to and from a memory 504a3. A battery 504a4 and on/off switch 504a5 may also be incorporated. Similarly, an interface system 504a6 may be used to interface with a BLUETOOTH® communications protocol signal transceiver 504a7 (hereinafter simply the “transceiver 504a7”), and a dedicated antenna 504a8 will typically be used to facilitate bidirectional communications by the transceiver 504a7. A “Harvest” button 504a9 allows the user to manually harvest the BLUETOOTH® communication protocol code of another individual when the user comes into proximity of the other individual. The software application 504a2 may alternatively be embodied in firmware associated with of the processor 504a1.

It will be appreciated that other wireless or wired communications protocols could be employed in place of the BLUETOOTH® communications protocol in both of the devices 502 and 504. For example, the ZIGBEE™ wireless communications protocol could be employed, which is based on the IEEE 802.15.4 wireless communications standard. Alternatively, a USB interface could also be used. In practice, any type of interface that allows users to conveniently interface their user device 502 or 504 to their respective computer or laptop could be employed.

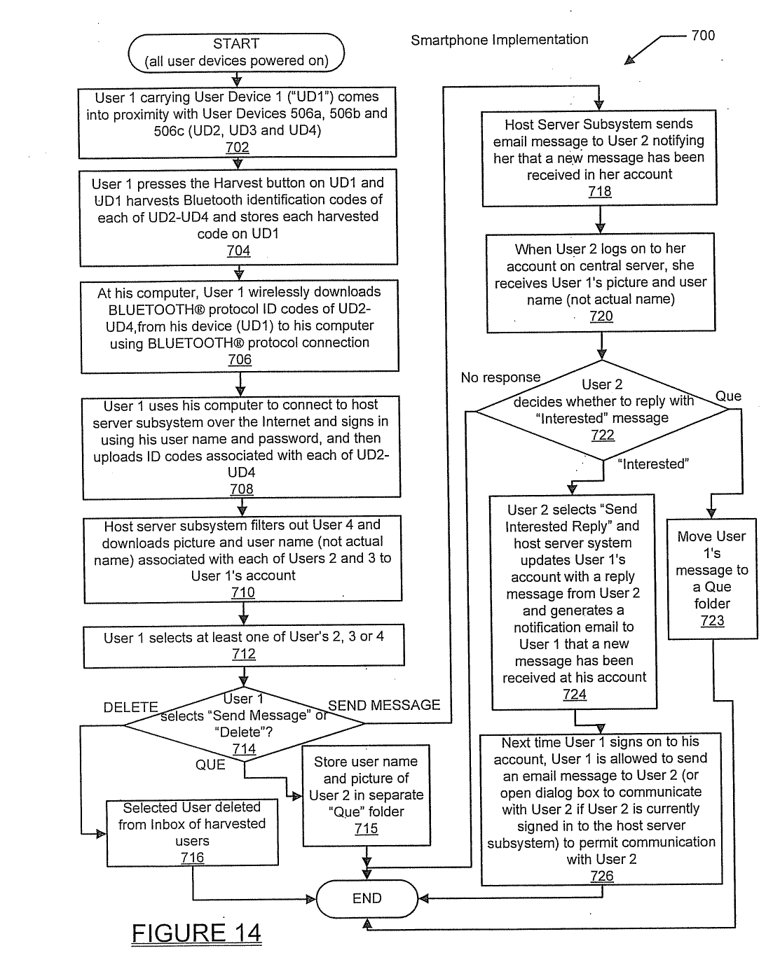

Referring briefly to FIG. 12, the host server subsystem 512 can be seen to include a processing subsystem 512a that may include an application filter 512d and one or more multimedia applications 512e. The multimedia applications 512e may be used to handle email messaging, instant messaging, video conferencing, audio files, or any other applications by which it is desired to enable the various users of the system 500 to communicate with one another. The application filter 512d will be described momentarily in connection with FIG. 13, but essentially this filter allows the user to filter the harvested identification codes received by his/her user device 502 so that only pictures and user names of users meeting predetermined criteria selected by User 1 will ultimately be provided to User 1. A registration/Log On module 512b handles registration and Log On operations and provides the interface for the host server subsystem 512 to the Internet. Users who have been registered to use the system 500 may be alternatively referenced herein as “registered users” or “subscribers” of the system 500. A database 510c of registered users is maintained that includes an account and associated user and billing information for each registered user. Each account may include one or more folders (not shown) for holding messages sent by users and replies to messages generated by the users. Options may be presented that enable each user to take action immediately with respect to sending a message to another user, or to defer taking action when receiving information pertaining any other user. This feature will also be discussed in greater detail in the following paragraphs.

Referring further to FIG. 11, a description of general operations for the system 500 will now be provided. For the purpose of description, the smartphone-type user device 502 will be referenced, although it will be appreciated that the same, or substantially similar, sequence of operations will be employed when using the dedicated, standalone user device 504. Also, it will be appreciated that some of the user devices 502 or 504 may be smartphone-type user devices while others are dedicated user devices (e.g., such as devices 504). Thus, there is no requirement that all of the user devices in operation with the system 500 conform to only one configuration of the user device.

The User 1 may turn on the subsystem 502a by selecting the application software 502a1 from a suitable menu option on the display of the user device 502. Once turned on, the user device 502 will begin periodically checking to for BLUETOOTH® communications protocol identification codes that are being transmitted from other devices. The frequency of this periodic checking can be varied during initial design of the subsystem 502a, but preferably the transceiver 502a3 will be controlled by the application software 502a1 such that a check for BLUETOOTH® communication protocol codes from other users' devices will be made by the transceiver 502a3 about once every 1-5 seconds. Alternatively, the transceiver 502a3 may be powered on so that it checks continuously for received BLUETOOTH® communication protocol codes from other devices.

When User 1 comes into proximity (typically 25-50 feet) of any other individual that he/she would be interested in meeting, User 1 presses the Harvest button 502a4 on his/her user device 502. In this example User 1 has come within the predetermined proximity of all of Users 2-4, and thus within the predetermined proximity of all three of user devices 506a-506c. This causes the device 502 to harvest (i.e., receive and store) the BLUETOOTH® communications protocol identification codes (hereinafter simply the “identification code” or “identification codes”) from each of user devices 506a-506c. As will be appreciated, the identification codes uniquely identify each user device 506a-506c, and thus uniquely identify each user associated with his/her respective user device 506a-506c. At about this time, if any one or more of Users 2-4 takes notice of User 1 and wishes to send a message to User 1, then any of Users 2-4 may press the Harvest button (button 502a4 or 504a9) on their respective user device 506a-506c and his/her user device will receive and store the BLUETOOTH® communication protocol code being transmitted from User 1's user device 502. Optionally, each user device 502 and 506 may be configured to provide an audible, tactile or visual signal when it has successfully harvested a new BLUETOOTH® communication protocol code some remote user device. Optionally, each user device could be configured to continuously or intermittently harvest identification codes from other user devices without any affirmative action by the user.

At some point User 1 may then bring his user device 502 into proximity with his laptop computer 508, which may also be a desktop computer or any other suitable form of computing device capable of making a wide area network connection. In this example the laptop 508 may also include a BLUETOOTH® communications protocol transceiver or “dongle” that allows the identification codes that have been harvested by user device 502 and stored thereon to be wirelessly downloaded to the laptop 508. User 1 may then use the laptop 508 to make a connection via a suitable network, for example and without limitation a wide area network, such as the Internet 510, with the host server subsystem 512. Alternatively, User 1 may first link to a local area network (not shown) before connecting to the Internet 510. Once connected to the host server subsystem 512, User 1 may log on to his/her account at the host server subsystem 512. User 1 may then upload the harvested identification codes on his/her user laptop 508 to the host server subsystem 512. The host server subsystem 512 may then access a database of subscriber information and obtain a picture and user name (not actual name) of each subscriber whose identification code was harvested by User 1's user device 502. This information will then be provided to User 1's account on the host server subsystem 512, and User 1 may thereafter download this information to his/her laptop 508 where User 1 is able to view the picture associated with each of the other subscribers associated with the identification codes that his/her user device 502 had previously harvested. User 1 may then select from various options, to be described in greater detail momentarily, to send a message to any one or more users associated with the identification codes that his/her user device 502 has harvested. For example, if User 2 is selected by User 1, then a message will be sent to User 2's account on the host server subsystem 512 that User 1 wishes to contact him/her. When User 2 logs on to his/her account at the host server subsystem 512, then he/she will be notified of the message and may then pick from various options whether to reply to User 1's inquiry for a contact. If User 2 agrees to a contact, then User 2's sends a reply using his/her laptop that may be used to generate an email message by the host server subsystem 512 that is delivered to User 1's account. When User 1 again checks his/her account at the host server subsystem 512, User 2's reply will be present. User 1 may then use his/her laptop or computer to open a dialog box and either send a follow up message with additional contact information to User 2 or attempt to initiate an on-line messaging session with User 2. In either event, additional opportunities will be afforded User 1 and User 2 to communicate so that a personal meeting can be initiated, provided both parties desire such. Up until this point, the actual names of User 1 and User 2 will not be known to each other.

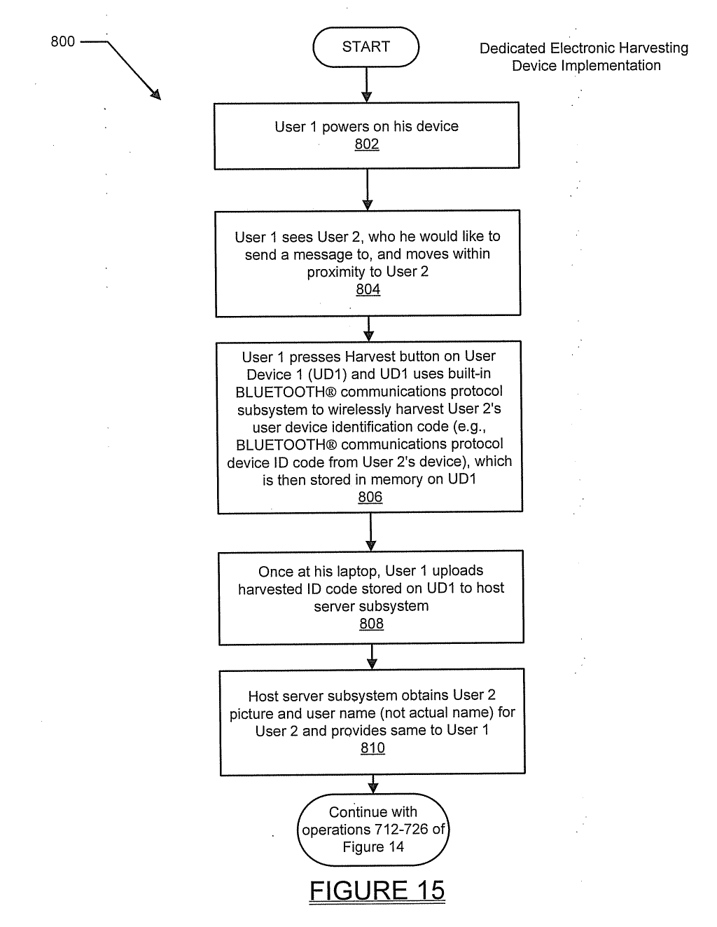

Referring now to FIGS. 13 and 14, a more detailed description will be provided of the options that the system 500 may incorporate, as well as a more detailed description of the sequence of operations that the system 500 performs when managing contacts between two users. With reference to FIG. 13, one example of a suitable registration process 600 using the host server subsystem 512 is shown. This registration process will preferably be performed by each user upon initially subscribing to use the system 500 and is handled by the registration/Log and interface module 512b of the host server subsystem 512. For the purpose of description, User 1 will be referenced and it will be assumed that User 1 is a male.

Initially at operation 602 User 1 may performs several actions: he provides his actual name along with his billing (i.e., credit card) information; he selects a user name; he selects a user password; he provides an email address; and he provides a picture of himself. Optionally he may provide additional personal information such as personal hobbies/interests, height/weight information, his age, occupation type (e.g., medical industry professional, legal industry professional), etc. At operation 604 the host server subsystem 512 assigns the identification code of User 1's device as his unique identification number. At operation 606 User 1 then configures the filter 512d (FIG. 12) associated with the processing subsystem 512a. For this example it will be assumed that User 1 is a male who desires to meet females that are interested in meeting men. User 1 will configure the filter 512d to select option 608, which will operate to prevent any information associated with males, or from females seeking females, from being delivered to User 1's account. Thus, for any identification codes harvested by User 1's user device 502, only those identification codes associated with female subscribers who are interested in meeting men will potentially have their user names and pictures delivered to User 1's account. Other filter options are shown as “Woman Seeking Men” (option 610); “Man Seeking Men” (option 612); and “Woman Seeking Women” (option 614). Thus, if option 612 was selected instead of option 608, then only the harvested identification codes associated with men who are interested in meeting other men would have their pictures and usernames potentially delivered to User 1's account. It will be appreciated, however, that the filter 512d could be configured to allow other classes of subscribers, for example those individuals that may be interested in meeting either men or women, or the filter could simply be configured to permit User 1 to select two or more filter options. Also, while the filter 512d is shown as part of the host server subsystem 512, it would also be possible to configure the filter within the application software 502a1 of the user device 502. Such a modification would likely require that other coded information be provided with the identification code of each user to indicate the user's gender and classification (i.e., woman interested in meeting men).

It will also be appreciated that each one of the filter options 608-614 could have associated with it a number of subfilters to further narrow the range of subscribers that could potentially be reported to User 1. For example, for filter option 608, additional filter options could be females with a given age range or possibly less than a certain age (option 608a); females with a certain height range or less than (or greater than) a certain height 608b; females having a specified race/ethnicity/religion (option 608c); females having a bodyweight within a given range or a specific body type (option 608d); or females with one or more of a number of specified personal interests such as sports, travelling, fitness, etc. (option 608e). It will be appreciated that the foregoing represents only a small number of the sub-filter categories that could be created to filter out only individuals that meet a specific subscriber profile. Sub-filters 610a-610c illustrate other potential subcategories by which a female seeking males could filter those subscribers that she wishes to provided with information on. At operation 616 the host server subsystem 512 configures the filter 512d with the selected categories and selections by User 1.

Turning now to FIG. 14, a more detailed description of one exemplary sequence of operation of the system 500 is shown in connection with flowchart 700. Initially it will be assumed that all of the user devices of FIG. 11 are powered on and that User 1 has a user device 502 that conforms to a smartphone-type device that includes the subsystem 502a, and further that User 1 is a male and that User 2 is a female.

At operation 702 User 1 comes into proximity with Users 2-4, and thus his user device 502 (UD1), which he is carrying on his person, is within the predetermined proximity of user devices 506a-506c (i.e., UD2, UD3 and UD4). At operation 704 User 1 presses the Harvest button 502a4 on his user device 502 and harvests the identification codes of each of UD2-UD4. User device 502 stores the identification codes in its memory (i.e., memory 502a2 shown in FIG. 11A). At operation 706, when User 1 is at his computer (laptop 508 or a desktop) he may wirelessly download the harvested identification codes from his user device 502 to his laptop 508 using the BLUETOOTH® wireless communications protocol. Alternatively he may use the ZIGBEE™ wireless communications protocol or he may even make a hardwired connection and use a USB cable connected to a USB port of his laptop 508 to achieve the needed interface. In any of the foregoing scenarios, the system 500 may be configured so that when a connection is made between the user device 502 and User 1's laptop 508 and the laptop 508 begins receiving the harvested identification codes, a web link is presented on User 1's laptop 508 display that User 1 can click on to go directly (over the Internet) to the website associated with the host server subsystem 512. Alternatively, the application software 502a1 may provide a selection (e.g., button) on the display of user device 502 that allows User 1 to make a connection over the Internet with the host server subsystem 512, and then to automatically upload the codes harvested by User 1's user device 502. In this manner User 1 could send a message to any one of Users 2-4 virtually within a minute or two of seeing Users 2-3, assuming the remote (i.e., Internet) connection can be immediately established.

Assuming that User 1 does not have Internet access directly from his user device 502, then at operation 708 User 1 uses his laptop 508 to connect to the host server subsystem 512 over the Internet and signs in using his user name and password. The host server subsystem 512 will open User 1's account and User 1 then uploads the harvested identification codes associated with each of UD2-UD4 from his laptop 508 to the host server subsystem 512. At operation 710 the host server subsystem 512 then checks the identification codes and determines which ones of the harvested identification codes correspond to subscribers of the system 500. Only for those identification codes corresponding to subscribers, the host server subsystem 512 then checks the filter that User 1 had previously configured to determine what, if any, restrictions User 1 has set up regarding the types of individuals he wishes to correspond with. In this example the host server subsystem 512 determines that User 4 does not meet the filter criteria that User 1 has set up, and thus removes User 4 from a list of subscribers that will be provided to UD1. However, the host server subsystem 512 determines that Users 2 and 3 are subscribers. Thus, only the user name and picture for Users 2 and 3 are then transmitted by the host server subsystem 512 to User 1's account and presented in a listing of subscribers that have been harvested by UD1. At operation 712 User 1 then selects the username and/or picture associated with User 2 for further action. At operation 714 User 1 is then presented with three options relative to User 2: “DELETE”, “SEND MESSAGE” or “QUE”. If User 1 decides he is not interested in pursuing further contact with User 2, then User 1 may delete the user name from his listing of subscribers that have been harvested, and the sequence of operations ends with regard to User 2. Optionally, User 1 may select to “QUE” User 2, which will move User 2's user name and picture to a different folder associated with User 1's account, as indicated at operation 715. In effect the “QUE” option allows User 1 the opportunity to send a message to User 2 at some later date, rather than deleting User 2 from the list of subscribers that User 1's user device has harvested. If User 1 selects the “SEND MESSAGE” option, then at operation 718 the host server subsystem 512 will send an email message to User 2's email account notifying her that a new message has been received in her email account indicating that a subscriber would like to contact her. At operation 720, when User 2 logs on to her account on the host server subsystem 512, she may open an email message that includes the user name (not actual name) and a picture of User 1. Optionally, User 2 could also be provided at this point with certain personal information on User 1, such as physical information (height/weight), interests, etc. It will be appreciated that User 2 may have configured a filter during her initial registration with the system 500. If User 1 does not meet the filter criteria that User 2 has set up, then no information concerning User 1 would be provided to User 2. For the purpose of this example it will be assumed that User 1 does meet the filter criteria that User 2 has set up.

At operation 722 User 2 may do nothing, in which case the sequence of operations relative to User 1 will end. Alternatively, User 2 may choose to send User 1 an “Interested” reply. In this event User 2 selects a “Send Interested Reply” option that may be presented along with User 1's user name and picture, and the host server subsystem 512 will update User 1's account with the reply email message from User 2. Optionally, the system 500 could be configured to send a notification message to User 1 (e.g., via text message to User 1's device 502) that a new message is present in his account, as indicated at operation 724. The next time User 1 signs on to his account at the host server subsystem 512, User 1 will be allowed to open a dialog box to send an email message directly to User 2's email account, as indicated at operation 726, or to open a dialog box to begin a messaging session directly with User 2 if User 2 is detected by the host server subsystem 512 as currently being signed in to her account. If at operation 722 User 2 does not wish to respond immediately to User 1's message, User 2 may also put User 1's message in a que, as indicated at operation 723. This essentially moves the message from User 1 to a separate folder within User 2's account where User 2 could, at some later date, choose to reply to the message. If User 2 simply chooses the “No response” option at operation 722, then the host server subsystem 512 may optionally delete User 1's message after a predetermined time period (e.g., 30 days).

Referring briefly now to FIG. 15, a flowchart 800 is illustrated to show an exemplary sequence of events that may occur when using the dedicated code harvester transceiver user device 504 (FIG. 11). Initially User 1 powers on his user device 504 via on/off switch 504a5 (FIG. 11B), as indicated at operation 802. At operation 804 User 1 sees User 2, who he would like to send a message to, and User 1 merely has to come within a predetermined distance of User 2 (e.g., 25-35 feet) to be able to harvest the identification code of User 2's user device 506 when pressing the Harvest button 504a9. At operation 806, User 1's user device 504 uses its built-in BLUETOOTH® communications protocol signal transceiver 504a7 (FIG. 11B) to wirelessly harvest User 2's device identification code, which is then stored in the memory 504a3 (FIG. 11B) of User 1's user device 504. At operation 808, once User 1 is back at his laptop 508 he downloads the harvested identification code of User 2 to his laptop using the BLUETOOTH® communications protocol transceiver 504a7, and then uploads the identification code from his computer over the Internet to the host server subsystem 512. Alternatively, the downloading of the harvested identification code may accomplished using any other wireless or wired communication protocol/interface as described herein. At operation 810 the host server subsystem 512 obtains User 2's picture and user name and provides same to User 1's account. The remaining operations are identical to operations 712-726 of FIG. 14.

From the above-described process, it will be appreciated that the system 500 provides a number of advantages and desirable features to an individual who is seeking to meet other individuals. Importantly, in the example above, User 1 will in almost all cases have actually seen Users 2-4 in person because User 1 will have been in close proximity to Users 2-4 when their identification codes were harvested by User 1's user device 502 (or 504). Another important advantage is that the code harvesting process occurs seamlessly, transparently and unobtrusively relative to all the users involved. When one user passes within a predetermined proximity of another user, the identification code of each user's device can be harvested simply by one user pressing the Harvest button on his user device. As will be appreciated, this is especially desirable in those situations where the two users are momentarily at a location where it might be inconvenient or impractical for one user to approach the other to make an introduction, or one (or both) of the users are uncomfortable with approaching the other directly to make an introduction. And also importantly, the system 500 enables both users to view a picture of the other before signaling an interest to communicate directly with the other. It will be appreciated then that the present system 500 and method eliminates the anxiety that is suffered by many individuals in making an in-person introduction of himself/herself to other individuals. The system 500 and method also can eliminate or substantially reduce the embarrassment that some individuals feel when an attempted in-person introduction is met with rejection by the other person.

While specific examples have been described in the specification and illustrated in the drawings, it will be understood by those skilled in the art that various changes may be made and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

What is claimed is:

1. A method for social networking comprising:
using a system to register a plurality of individuals who will be users of a social network;
providing a plurality of electronic devices to each of the users that are carried by each of the users, with each said electronic device having an identification code and being able to wirelessly harvest the identification code of any other one of the electronic devices when two or more of the electronics devices come within a predetermined distance of one another;
using a first one of the electronic devices to wirelessly harvest the identification code of a second one of the electronic devices when the first and second electronic devices come within the predetermined distance of one another, and wherein the first electronic device is associated with a first user who is registered with the system and the second electronic device is associated with a second user who is registered with the system; and
using the system to coordinate messaging and a transfer of predetermined information between the first and second users.

2. The method of claim 1, wherein using the system to coordinate messaging comprises:
using the system to receive the identification code of the second electronic device that has been harvested by the first electronic device;
using the system to provide information related to the second user to the first user;
using the system to enable the first user to initiate a message that is sent to the second user informing the second user that the first user would like to contact the second user; and
using the system to enable the second user to initiate a reply message that is sent to the first user informing the first user that the second user is interested in communicating further with the first user.

3. The method of claim 1, wherein the information related to the second user that is provided to the first user includes a picture of the second user.

4. The method of claim 1, wherein the message from the first user to the second user is generated by the system and includes a picture of the first user.

5. The method of claim 1, wherein after the first user receives the information concerning the second user from the system, the first user may also select to hold the information in a que for further consideration at a later date.

6. The method of claim 1, wherein after the second user receives the message from the first user, the second user is also provided with an option by the system for holding the message from the first user in a que, to therefore enable a reply to the message of the first user at a subsequent time.

7. The method of claim 1, wherein the information that the first user is presented with includes a picture of the second user and a user name of the second user.

8. The method of claim 1, wherein the message that is sent to the second user informing the second user of the first user's interest in making contact includes a picture of the first user and a user name of the first user.

9. The method of claim 1, wherein the operation of using a system to register a plurality of individuals as users of a social network includes enabling each said user to configure a filter associated with the system that limits information being supplied to each of the users to only other ones of the users who meet at least one predefined criterion.

10. The method of claim 9, wherein the at least one predefined criterion comprises at least one of the following categories of users of the system:
man seeking women;
woman seeking men;
man seeking men; and
woman seeking women.

11. The method of claim 10, wherein at least one of the categories for filtering said users includes subcategories related to at least one of the following criteria:
age;
height;
race or ethnicity or religion;
weight or body type; and
interests or hobbies.

12. The method of claim 1, wherein the second user's second electronic device is also able to wirelessly harvest the identification code of the first user's first electronic device when the first and second electronic devices come within the predetermined distance of one another.

13. A system for social networking comprising:
a host subsystem for containing information about a plurality of users who are registered to use the social networking system, and providing an account for each said user who is registered to use the system;
a plurality of electronic user devices that are unique associated with each of the users, with each of the electronic user devices including a unique identification code;
each of the electronic user devices including a wireless communications transceiver for wirelessly transmitting the identification code of its respective said electronic user device, and for wirelessly receiving the identification codes of other ones of the electronic user devices when any two or more ones of the electronic user devices come within a predetermined distance of one another;
each of the electronic user devices further being adapted to store received identification codes from other ones of the electronic user devices and to enable uploading of the identification codes stored thereon to the host subsystem; and
the host subsystem adapted to manage and coordinate messaging between the users associated with the received identification codes.

14. The system of claim 13, wherein the host subsystem is further adapted to:
coordinate transmitting information associated with each said user whose said identification code has been received by the electronic user device of a first one of the user's to the first user;
to enable the first user to select at least one second user from the group of users associated with the received identification codes that the first user wishes to send a message to;
to generate a message to the second user;
to enable the second user to be provided with certain information pertaining to the first user; and
to enable the second user to send a reply message to the first user when the second user wishes to communicate further with the first user.

15. The system of claim 13, wherein the host subsystem is adapted to provide a picture and a user name to the first user corresponding to each one of the other users for whom identification codes have been received by the first user's electronic user device

16. The system of claim 13, wherein each one of the electronic user devices includes a wireless transceiver that employs a wireless communications protocol that transmits its said identification code upon a command from its associated said user, and wirelessly receives the identification codes of other remote ones of the electronic user devices of other ones of the users without action by the associated said user.

17. The system of claim 13, wherein the host subsystem includes a database for storing information pertaining to each one of the users who is registered to use the system.

18. The system of claim 13, wherein the host subsystem includes an application filter that allows each of the users who are registered to use the system to filter received identification codes from other ones of the users in accordance with at least one of the following criteria:
man seeking women;
woman seeking men;
man seeking men; and
woman seeking women.

19. A social networking system comprising:
a host server subsystem for containing information about a plurality of users who are registered to use the social networking system, and providing an account for each said user who is registered to use the system;
a plurality of electronic user devices that are associated with each of the users, with each of the electronic user devices including a unique identification code;
each of the electronic user devices including a wireless communications transceiver for wirelessly transmitting the identification code of its respective said electronic user device, and for wirelessly receiving the identification codes of other ones of the electronic user devices when any two or more ones of the electronic user devices come within a predetermined distance of one another;
each of the electronic user devices further being adapted to store received identification codes from other ones of the electronic user devices and to enable uploading of the identification codes stored thereon to the host server subsystem; and
the host server subsystem adapted to:
coordinate transmitting information associated with each said user, whose said identification code has been received by the electronic user device of a first one of the user's, to the first user;
to enable the first user to select at least one second user from the group of users associated with the received identification codes that the first user wishes to send a message to;
to generate a message to the second user;
to enable the second user to be provided with a picture of the first user; and
to enable the second user to send a reply message to the first user when the second user wishes to communicate further with the first user.

20. The system of claim 19, wherein the host server subsystem includes an application filter that enables each said registered user of the system to establish filtering criteria by which identification codes associated with other ones of the registered users will be filtered, such that a given one of the registered users is only able to receive messages from other ones of the registered users meeting the filtering criteria established by the given one of the registered users; and
wherein the filtering criteria established by the application filter includes at least two of the following categories:
man seeking women;
woman seeking men;
man seeking men; and
woman seeking women.
